(19) United States
(12) Patent Application Publication
(10) Pub. No.: US 2014/0103763 A1
(43) Pub. Date: Apr. 17, 2014

(54) DIRECT DRIVE THREADED ROD TRANSMISSION MECHANISM

(71) Applicant: HIWIN MIKROSYSTEM CORP., Taichung City (TW)

(72) Inventor: Yung-Tsai CHUO, TAICHUNG CITY (TW)

(73) Assignee: HIWIN MIKROSYSTEM CORP., Taichung City (TW)

(21) Appl. No.: 13/671,821

(22) Filed: Nov. 8, 2012

(30) Foreign Application Priority Data
Oct. 17, 2012 (TW) 101138168

(51) Int. Cl. H02K 7/06

(52) U.S. Cl. CPC H02K 7/06
USPC 310/83

(57) ABSTRACT

A direct drive threaded rod transmission mechanism is provided. The direct drive threaded rod transmission mechanism is characterized in that a part of the threaded rod is a part of the rotor section of a torque motor. Accordingly, the threaded rod is combined with the torque motor into an integrated body and the torque motor can directly drive the threaded rod. Therefore, the components are simplified and the volume is minified and the assembling and processing cost is lowered.

### BACKGROUND OF THE INVENTION

1. Field of the Invention

The present invention relates generally to a transmission technique, and more particularly to a direct drive threaded rod transmission mechanism.

2. Description of the Related Art

A conventional ball threaded rod or Acme threaded rod is used as a transmission component disposed between a power source such as a motor and an operation component such as a slide seat. The threaded rod serves to convert the rotational move of the motor into linear move of the slide seat or convert the torque into reciprocating force. Such threaded rod is widely applied to different fields such as tool machines, IT, photoelectrical techniques, semiconductor techniques and medical techniques as a good transmission component.

Substantially, when the threaded rod is used as a transmission component, the rotational power output from the output shaft of the motor must be transmitted through a reducing gear to the threaded rod for rotating the threaded rod by a proper rotational speed. In some other cases, the threaded rod is connected to the shaft of the motor via a shaft coupler for transmitting the power. In these conventional techniques, a transmission mechanism must be additionally disposed between the shaft of the motor and the threaded rod for transmitting the power. Therefore, the number of the components is increased and the assembling and processing procedure is complicated. This leads to low manufacturing efficiency and increase of manufacturing cost.

### SUMMARY OF THE INVENTION

It is therefore a primary object of the present invention to provide a direct drive threaded rod transmission mechanism. In the direct drive threaded rod transmission mechanism, a part of the threaded rod is a part of the rotor section of a torque motor. Accordingly, the torque motor can directly drive the threaded rod to rotate. Therefore, the number of the components is reduced and the processing procedure is simplified to increase manufacturing efficiency and lower manufacturing cost.

To achieve the above and other objects, the direct drive threaded rod transmission mechanism of the present invention includes: an inner rotor torque motor having a body section, an annular stator section disposed in the body section and a rotor section positioned in the stator section; and a threaded rod coaxially positioned at a curvature center of the stator section. The threaded rod has a threaded rod section and a shaft section free from any thread. The shaft section is coaxial with the threaded rod section. The threaded rod transmission mechanism is characterized in that the shaft section of the threaded rod is directly used as a rotary shaft of the rotor section and multiple magnets of the rotor section are fixedly disposed on a circumference of the shaft section.

In the above direct drive threaded rod transmission mechanism, the magnets are directly fixedly attached to the circumference of the shaft section.

In the above direct drive threaded rod transmission mechanism, the rotor section includes a tubular sleeve and the shaft section of the threaded rod is coaxially fixedly fitted in the sleeve. The magnets are fixedly attached to a circumference of the sleeve.

The present invention can be best understood through the following description and accompanying drawings, wherein:

### BRIEF DESCRIPTION OF THE DRAWINGS

FIG. 1 is a perspective assembled view of a preferred embodiment of the present invention;

FIG. 2 is a perspective generally exploded view of the preferred embodiment of the present invention; and

FIG. 3 is a sectional assembled view of the preferred embodiment of the present invention.

### DETAILED DESCRIPTION OF THE PREFERRED EMBODIMENTS

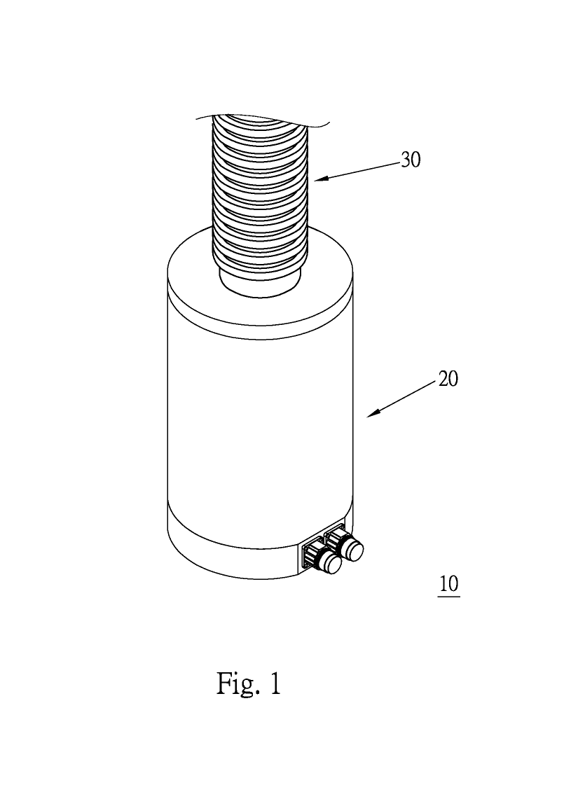

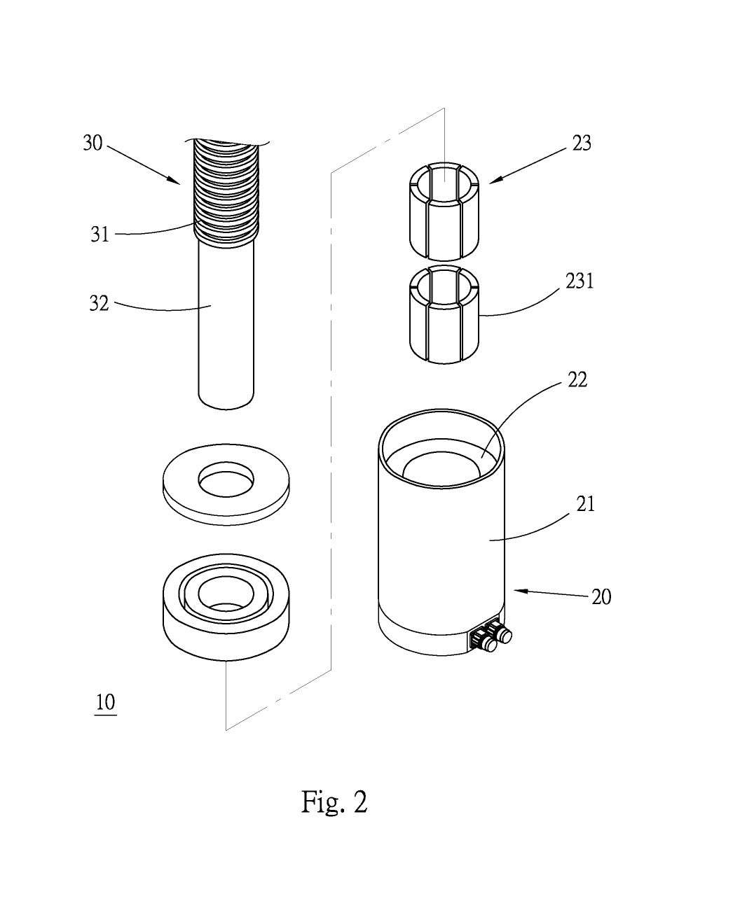

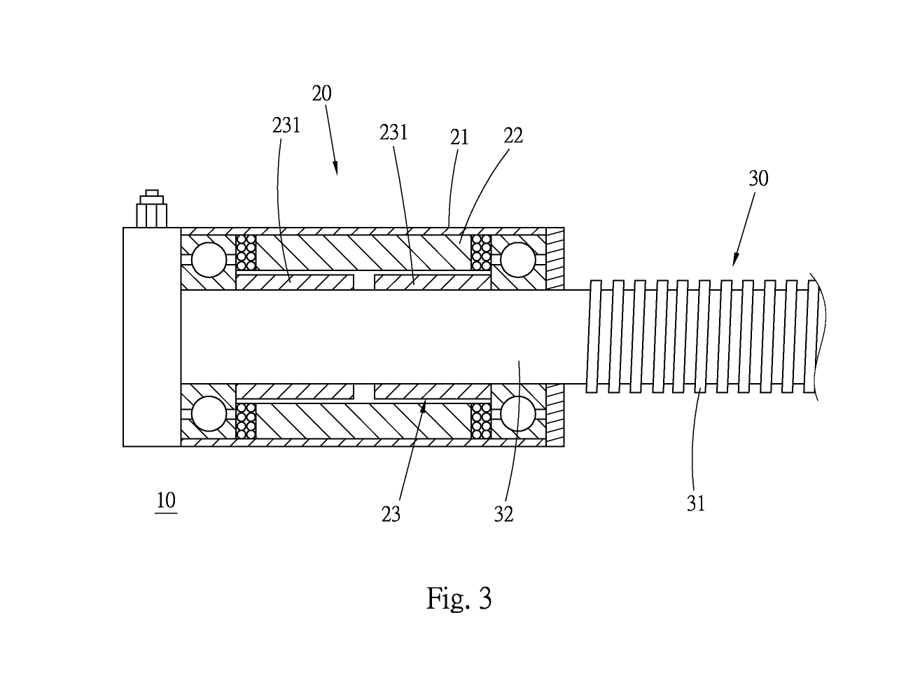

Please refer to FIGS. 1 to 3. According to a preferred embodiment, the direct drive threaded rod transmission mechanism 10 of the present invention includes an inner rotor torque motor 20 and a threaded rod 30.

The torque motor 20 is substantially identical to a conventional direct drive motor. The torque motor 20 has a body section 21, an annular stator section 22 fixedly disposed in the body section 21 and a rotor section 23 positioned at a curvature center of the stator section 22. Under electromagnetic force, the rotor section 23 can rotate.

The threaded rod 30 is a ball threaded rod having a threaded rod section 31 and a shaft section 32 free from any thread. The shaft section 32 is coaxially integrally connected with the threaded rod section 31.

The shaft section 32 coaxially extends into the stator section 22 to serve as the rotary shaft of the rotor section 23. Multiple magnets 231 of the rotor section 23 are fixedly attached to the circumference of the shaft section 32. Accordingly, under electromagnetic force, the shaft section 32 with the magnets 231 is directly driven to rotate. The shaft section 32 is integrally connected with the threaded rod section 31 so that the threaded rod 30 is directly rotated without using any transmission mechanism such as reducing gear or shaft coupler as in the conventional technique.

In comparison with the conventional technique, the direct drive threaded rod transmission mechanism 10 of the present invention has simplified components and is easy to assemble and process. Therefore, the assembling and processing procedures of the direct drive threaded rod transmission mechanism 10 of the present invention are simplified. Also, the structure of the direct drive threaded rod transmission mechanism 10 of the present invention is simplified so that the direct drive threaded rod transmission mechanism 10 is easy to maintain and service and is more reliable.

To speak more specifically, the present invention is mainly characterized in that the threaded rod is directly used as the rotary shaft of the rotor section instead of the rotor section of the conventional torque motor. The magnets can be sequentially annularly arranged on the shaft section 32 in another manner without limitation to the above embodiment. For example, the rotor section can have a tubular sleeve and the magnets can be sequentially annularly arranged on the sleeve. Then the shaft section of the threaded rod is coaxially fixedly fitted in the sleeve. This can achieve the same object that the shaft section of the threaded rod serves as the rotary shaft of the rotor as the above embodiment.

The above embodiments are only used to illustrate the present invention, not intended to limit the scope thereof. Many modifications of the above embodiments can be made without departing from the spirit of the present invention.

What is claimed is:

1. A direct drive threaded rod transmission mechanism comprising:
an inner rotor torque motor having a body section, an annular stator section disposed in the body section and a rotor section positioned in the stator section; and
a threaded rod coaxially positioned at a curvature center of the stator section, the threaded rod having a threaded rod section and a shaft section free from any thread, the shaft section being coaxial with the threaded rod section, the threaded rod transmission mechanism being characterized in that the shaft section of the threaded rod is directly used as a rotary shaft of the rotor section and multiple magnets of the rotor section are fixedly disposed on a circumference of the shaft section.

2. The direct drive threaded rod transmission mechanism as claimed in claim 1, wherein the magnets are fixedly attached to the circumference of the shaft section.

3. The direct drive threaded rod transmission mechanism as claimed in claim 1, wherein the rotor section includes a tubular sleeve and the shaft section of the threaded rod is coaxially fixedly fitted in the sleeve, the magnets being fixedly attached to a circumference of the sleeve.
